(19) United States
(12) Patent Application Publication
(10) Pub. No.: US 2026/0279306 A1
(43) Pub. Date: Sep. 17, 2026

(54) METHOD AND SYSTEM FOR VEHICLE DISPLAY WITH ADAPTIVE VISUAL CONTENT

(71) Applicant: Autosystems, a division of Magna Exteriors Inc., Aurora (CA)

(72) Inventors: Buenyamin Uzun, Holzgerlingen (DE); Frank Hallitschke, Backnang (DE); Daniel Rzymanek, Karvina (CZ)

(21) Appl. No.: 19/535,475

(22) Filed: Feb. 10, 2026

Related U.S. Application Data
(60) Provisional application No. 63/770,651, filed on Mar. 12, 2025.

(51) Int. Cl. G09G 5/00; G06F 40/40; G06T 11/60; G06V 20/58; G07C 5/04

(52) U.S. Cl. CPC G09G 5/003; G06F 40/40; G06T 11/60; G06V 20/58; G07C 5/04; G09G 2340/0407; G09G 2380/10

(57) ABSTRACT

A method for operating a display unit of a vehicle includes: showing a visual content on the display unit and which is visible to an observer outside of the vehicle; sensing at least one of: a condition of the vehicle or an ambient condition around the vehicle; and adjusting, based on the at least one of the condition of the vehicle or the ambient condition around the vehicle, the visual content shown on the display unit. A vehicle-to-anything (V2X) communication system for a vehicle is also provided and includes: a display unit onboard the vehicle and configured to show a visual content which is visible to an observer outside of the vehicle, a sensor, and a controller configured to adjust the visual content shown on the display unit based on at least one of: a condition of the vehicle or an ambient condition around the vehicle.

### CROSS REFERENCE TO RELATED APPLICATIONS

This utility patent application claims the benefit of U.S. Provisional Patent Application No. 63/770,651, filed Mar. 12, 2025, the contents of which is incorporated herein by reference in its entirety.

### FIELD

The present disclosure relates generally to graphic displays for vehicles. Specifically, the present disclosure relates to methods and systems for controlling a graphic display on a motor vehicle for effectively communicating information to viewers outside of the vehicle.

### BACKGROUND

A vehicle, such as a passenger car or truck may have a display unit configured to convey information to viewers outside of the vehicle. The advancement of vehicles with regard to autonomous driving leads to a decrease in interaction and communication between the driver or the vehicle and other road users (such as vehicles and pedestrians).

It would be advantageous to use existing or additional technologies on a vehicle to provide vehicle-to-anything (V2X) communication between the vehicle and any entity that may affect, or may be affected by, the vehicle. For non-autonomous vehicles, V2X communication can increase road safety by communicating recognized dangers to other road users.

### SUMMARY

The present disclosure provides a method for operating a display unit of a vehicle. The method includes: showing a visual content on the display unit and which is visible to an observer outside of the vehicle; sensing at least one of: a condition of the vehicle or an ambient condition around the vehicle; and adjusting, based on the at least one of the condition of the vehicle or the ambient condition around the vehicle, the visual content shown on the display unit.

The present disclosure also provides a vehicle-to-anything (V2X) communication system for a vehicle. The V2X communication system includes: a display unit onboard the vehicle and configured to show a visual content which is visible to an observer outside of the vehicle; a sensor configured to sense at least one of: a condition of the vehicle or an ambient condition around the vehicle; and a controller. The controller is configured to adjust the visual content shown on the display unit based on the at least one of the condition of the vehicle or the ambient condition around the vehicle.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a schematic block diagram of a vehicle-to-anything (V2X) communication system for a vehicle, in accordance with an aspect of the present disclosure.

FIG. 2 shows a schematic block diagram illustrating a control program for operating a vehicle-to-anything (V2X) communication system, in accordance with an aspect of the present disclosure.

FIG. 3 shows a flow chart of steps in a method for operating a display unit of a vehicle, in accordance with some embodiments of the present disclosure.

### DETAILED DESCRIPTION

Referring to the drawings, the present invention will be described in detail in view of following embodiments.

By using individually controllable light sources, such as OLEDs, miniLEDs or microLEDs, texts or symbols can be communicated, display or display-like technology. This type of technology can already be seen on some vehicles today. Conventional onboard display units may use graphics that may be predefined in terms of resolution and display and which may be only "called up" to be displayed.

The present disclosure provides for linking link the onboard display with the vehicle's sensor information, e.g. speed, distance, etc.. This information is constantly monitored by the display controller and used to optimally adapt/scale the resolution of the display to the situation. The system and method of the present disclosure may adapts the resolution of predefined texts and graphics to the conditions based on the sensor information from the vehicle, and to optimize the graphic display for readability. This may adapt the V2X communication to a variety of real-world conditions.

The invention consists of a controller unit and the display unit, which can be designed either separately or together as a product. The controller establishes the connection to the vehicle and serves as a receiver of signals/information and at the same time gives the vehicle status feedback.

There may be various inputs such as:
The content to be displayed in the form of text or geometries, for example. This is determined in advance and can be stored in a memory location in the vehicle or on the controller;
Speed, which is recorded by various sensors in the vehicle;
Distance to objects around the vehicle, which are recorded by sensors and cameras;
Type of object (e.g. car, pedestrian, cyclist, etc.), which are recorded by sensors and cameras;
Weather conditions

Using this information, the output for the display in the controller may be adjusted in size and/or resolution. A restriction of the display depending on the inputs can also be specified. Some example specifications are described below. However, the invention is not limited to these examples and can be expanded within the framework of the basic idea.

In an example method, the visual content on a display screen may be adjusted based on one or more sensed parameters, such as speed. Where V= speed:
1. V = 0 → highest resolution (e.g. every pixel) since we may assume that the object is close to the subject vehicle;
2. V > 0 OR bad weather conditions → start grouping the pixels, which results in lower resolution but better readability from a distance;
3. V = 0 → display all images and also animations, any content
4. V > 0 → display only safety-related symbols, numbers and what is legally allowed to be displayed.

The present disclosure provides a method and system for adjusting one or more of a display resolution and/or a size of a visual content based on a condition of the subject vehicle or an ambient condition around the subject vehicle. It may include limiting the visual content, such as information and/or graphics displayed. The method and system may make the adjustments to the visual content based on input information from the vehicle, such as speed, distance to objects around the vehicle, type of objects and/or weather conditions.

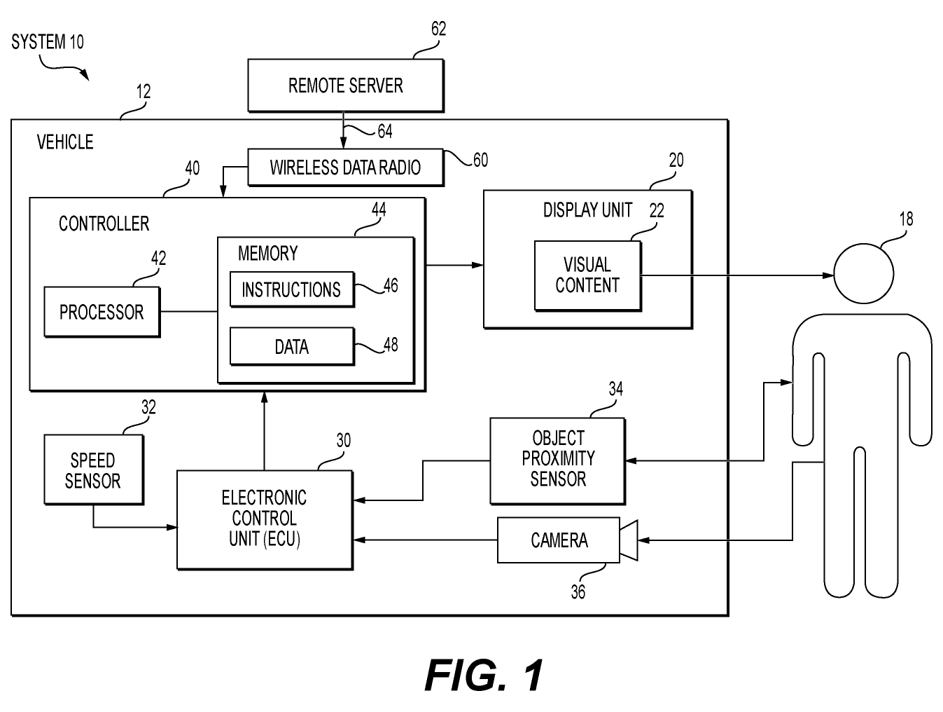

As shown in FIG. 1, a schematic block diagram of a vehicle-to-anything (V2X) communication system 10 is provided. The system 10 includes a vehicle 12 with a display unit 20 onboard the vehicle and configured to show a visual content 22 which is visible to an observer 18 outside of the vehicle 12. The visual content 22 may include graphics, text, animations, etc. The visual content 22 may pertain to conditions and/or status of the vehicle 12. For example, the visual content 22 presented on the display unit 20 may include information initiated by an operator of the vehicle 12 (either a human operator or an automated driving system), such as a turn signal indicator or a hazard warning. In some embodiments, the visual content 22 presented on the display unit 20 may include information regarding detected or known hazards, such as an obstacle detected in the roadway or an icy condition of the roadway.

The V2X communication system 10 also includes an electronic control unit (ECU) 30, which may be a part of an advanced driver assistance system (ADAS) or another onboard system of the vehicle 12, and which receives information from one or more sensors 32, 34, 36 regarding the vehicle 12 and ambient conditions around the vehicle 12. The ECU 30 may include one or more controllers, such as an ADAS controller, a body control module (BCM) and/or a powertrain control module (PCM). The V2X communication system 10 also includes a speed sensor 32 that is configured to measure a speed of the vehicle 12.

The V2X communication system 10 also includes an object proximity sensor 34 that is configured to determine a location and/or path of a sensed object, such as the observer 18. The sensed object may include another vehicle, an obstacle, a pedestrian, and/or a cyclist. The object proximity sensor 34 may use sonar, radar, LIDAR, another sensing technique, or a combination of techniques to measure the location and/or path of the sensed object. The location and/or path of the sensed object may include a distance and/or heading to the sensed object, and/or a relative velocity of the sensed object relative to the vehicle 12. The V2X communication system 10 also includes a camera 36 that is configured to optically sense the sensed object. The ECU 30 may use the object proximity sensor 34 and/or the camera 36 in order to classify the sensed object. For example, the ECU 30 may determine the sensed object being one of a pedestrian, a passenger car, a motorcycle, a bicycle, etc.

In some embodiments, the camera 36 and/or one or more other sensors may measure other ambient conditions around the vehicle 12, such as a weather condition or a traction condition of the roadway.

The V2X communication system 10 also includes a controller 40 in communication with each of the display unit 20 and the ECU 30. The display unit 20 also be called a display controller. The controller 40 may be configured to control one or more characteristics of the visual content 22 shown on the display unit 20. The display unit 20 may adjust the visual content 22 shown on the display unit 20 based on the condition of the vehicle 12 and/or an ambient condition around the vehicle 12.

The controller 40 includes a processor 42 coupled to a storage memory 44. The storage memory 44 includes instruction storage 46 storing instructions, such as program code for execution by the processor 42. The storage memory 44 also includes data storage 48 for holding data for use by the processor 42. In some embodiments, the processor 42 may be programmed and/or otherwise configured to perform one or more artificial intelligence (AI) and/or machine learning (ML) functions. For example, the processor 42 may include one or more functional units that are optimized for AI/ML functionality. In some embodiments, the AI/ML functionality may be performed by a large language model (LLM). The LLM may include a transformer-based architecture, such as a generative pre-trained transformer (GPT). However, other artificial intelligence (AI) architectures, such as other deep learning or other transformer-based AI architectures may be used to implement the LLM.

In some embodiments, the program instructions stored in the instruction storage 46 may implement the LLM and/or one or more other AI/ML algorithms. Alternatively or additionally, the processor 42 may execute program code that causes one or more other computers, such as remote servers, to perform an AI/ML function, such as by sending instructions or prompts to the LLM running on the one or more other computers.

The V2X communication system 10 also includes a wireless data radio 60 onboard the vehicle and configured to receive data from a remote server 62 via a wireless data connection 64. The wireless data connection 64 may include a cellular data network, the Internet, and/or other computer networks. The wireless data radio 60 may receive data regarding ambient conditions around the vehicle 12 and provide such information to the controller 40. For example, the wireless data radio 60 may receive information regarding weather conditions, traffic conditions, roadway conditions, road construction, etc. The controller 40 may use such information in order to adjust the visual content 22 shown on the display unit 20.

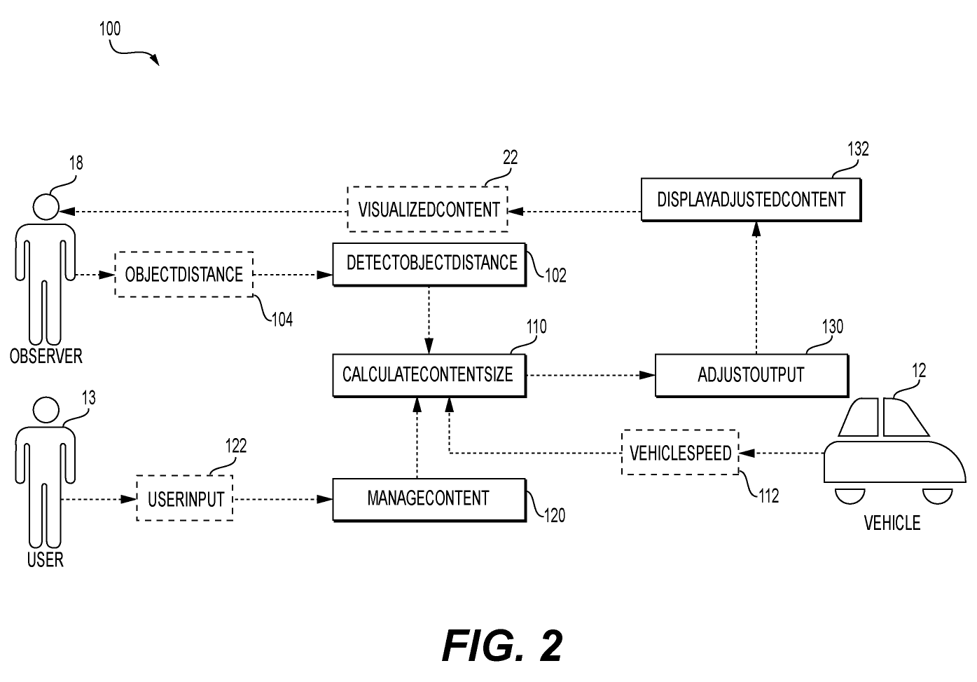

FIG. 2 shows a schematic block diagram illustrating a control program 100 for operating a vehicle-to-anything (V2X) communication system, in accordance with an aspect of the present disclosure. The control program 100 may describe functions performed by the controller 40 and/or the ECU 30 of the V2X communication system 10.

The control program 100 includes an object distance calculator 102 that is configured to determine a distance to the observer 18 based on object distance data 104. The object distance data 104 may include data from one or more sensors 34, 36, such as the object proximity sensor 34 and/or the camera 36. It should be appreciated that the object distance data 104 may include raw data from one or more cameras 36 and/or other sensors. Additionally or alternatively, the object distance data 104 may include sensor fusion data based on a combination of data from two or more different sensors 34, 36.

The control program 100 also includes a content size calculator 110 that is configured to determine a size of content to be presented on the display unit 20 based on the distance to the observer 18, as provided from the object distance calculator 102. In some embodiments, and as shown on FIG. 2, the content size calculator 110 may also receive a vehicle speed signal 112. The content size calculator 110 may be further configured to determine the size of content to be presented on the display unit 20 based on the vehicle speed signal 112. For example, larger messages may be presented as the vehicle 12 travels faster. The display unit 20 may present smaller size text or graphics when the vehicle speed is below a predetermined threshold speed.

The control program 100 also includes a content manager 120 that is configured to determine content to be presented on the display unit 20 based on a user input 122 from a user 13, such as an operator of the vehicle 12. The user input 122 may include messages to be presented on the display unit 20, such as a driver intention to brake or turn. The content size calculator 110 may be further configured to determine the size of content to be presented on the display unit 20 based on an output from the content manager 120. For example, larger messages or a larger number of messages to be presented simultaneously may necessitate each of the messages to be smaller in order to fit on the display unit 20.

The control program 100 also includes an adjust output function 130 that adjusts a command for the visualized content 22 based on an output from the content size calculator 110. The control program 100 also includes a display adjusted content function 132 that causes the display unit 20 to display the visualized content 22 for viewing by the observer 18 outside of the vehicle, and where the visualized content 22 is adjusted both for a given content and for the size of the content in order to optimize the ability of the observer 18 to view and to understand the visualized content.

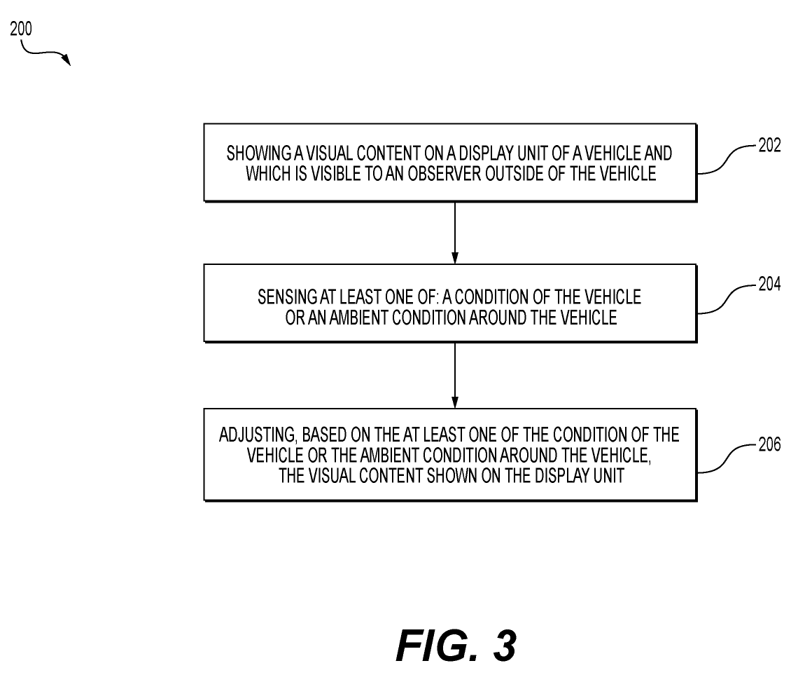

A method 200 for operating a display unit of a vehicle is shown in the flow chart of FIG. 3. The method 200 can be performed by the V2X communications system 10, in accordance with some embodiments of the present disclosure. As can be appreciated in light of the disclosure, the order of operation within the method is not limited to the sequential execution as illustrated in FIG. 3, but may be performed in one or more varying orders as applicable and in accordance with the present disclosure.

The method 200 includes showing a visual content on the display unit and which is visible to an observer outside of the vehicle, at step 202. For example, the controller 40 may cause the display unit 20 to show the visual content 22 in order for the visual content 22 to be seen and understood by an observer 18 outside of the vehicle 12. In some embodiments, the visual content may be generated using the LLM. For example, the 42 may generate the visual content directly and/or transmit a prompt or request to an LLM running on a remote computer to cause the LLM to generate the visual content.

The method 200 also includes sensing at least one of: a condition of the vehicle or an ambient condition around the vehicle, at step 204. For example, one or more of the sensors 34, 36 may sense a condition of the vehicle, such as a speed and/or an ambient condition, such as weather and/or distance to an object.

The method 200 also includes adjusting, based on the at least one of the condition of the vehicle or the ambient condition around the vehicle, the visual content shown on the display unit, at step 206. For example, the controller 40 may cause the display unit 20 to adjust the visual content 22 based on the condition of the vehicle 12 or the ambient condition around the vehicle 12 in order to make the visual content 22 more likely to be seen and understood by the observer 18 outside of the vehicle 12.

In some embodiments, adjusting the visual content includes adjusting a display resolution of the visual content shown on the display unit.

In some embodiments, adjusting the visual content includes adjusting a size of the visual content shown on the display unit.

In some embodiments, adjusting the visual content includes reducing the visual content shown on the display unit.

In some embodiments, adjusting the visual content includes providing, to a large language model (LLM), the at least one of the condition of the vehicle or the ambient condition around the vehicle as one or more prompts. In some embodiments, adjusting the visual content further includes and generating, by the LLM, a revised visual content based on the one or more prompts provided thereto. The revised visual content may replace existing visual content or otherwise be presented on the display unit, such as in subsequent instances of step 206. In some embodiments, the LLM may be implemented using hardware and/or software located entirely onboard the vehicle 12, such as by the controller 40. Additionally or alternatively, the LLM may be implemented partially or entirely using one or more remote computers that are spaced apart from the vehicle 12 and which are in communication with the controller 40, such as by using a mobile data network.

In some embodiments, the at least one of the condition of the vehicle or the ambient condition around the vehicle includes a speed of the vehicle.

In some embodiments, the at least one of the condition of the vehicle or the ambient condition around the vehicle includes a distance to an object outside of the vehicle.

In some embodiments, the at least one of the condition of the vehicle or the ambient condition around the vehicle includes an object type of an object outside of the vehicle.

In some embodiments, the at least one of the condition of the vehicle or the ambient condition around the vehicle includes a weather condition around the vehicle.

In some embodiments, the method 200 may further include receiving, by a wireless data radio onboard the vehicle and from a remote source data regarding the ambient condition around the vehicle. For example, the wireless data radio 60 may receive information from the remote server 62 regarding weather conditions, traffic conditions, roadway conditions, road construction, etc., and which may be sent to the controller 40 in order to adjust the visual content 22 shown on the display unit 20.

The system, methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors, processor architectures, combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionalities may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for operating a display unit of a vehicle, comprising:
showing a visual content on the display unit and which is visible to an observer outside of the vehicle;
sensing at least one of: a condition of the vehicle or an ambient condition around the vehicle; and
adjusting, based on the at least one of the condition of the vehicle or the ambient condition around the vehicle, the visual content shown on the display unit.

2. The method of claim 1, wherein adjusting the visual content includes adjusting a display resolution of the visual content shown on the display unit.

3. The method of claim 1, wherein adjusting the visual content includes adjusting a size of the visual content shown on the display unit.

4. The method of claim 1, wherein adjusting the visual content includes reducing the visual content shown on the display unit.

5. The method of claim 1, wherein adjusting the visual content includes:
providing, to a large language model (LLM), the at least one of the condition of the vehicle or the ambient condition around the vehicle as one or more prompts; and
generating, by the LLM, a revised visual content based on the one or more prompts provided thereto.

6. The method of claim 1, wherein the at least one of the condition of the vehicle or the ambient condition around the vehicle includes a speed of the vehicle.

7. The method of claim 1, wherein the at least one of the condition of the vehicle or the ambient condition around the vehicle includes a distance to an object outside of the vehicle.

8. The method of claim 1, wherein the at least one of the condition of the vehicle or the ambient condition around the vehicle includes an object type of an object outside of the vehicle.

9. The method of claim 1, wherein the at least one of the condition of the vehicle or the ambient condition around the vehicle includes a weather condition around the vehicle.

10. The method of claim 1, further including receiving, by a wireless data radio onboard the vehicle and from a remote source data regarding the ambient condition around the vehicle.

11. A vehicle-to-anything (V2X) communication system for a vehicle, comprising:
a display unit onboard the vehicle and configured to show a visual content which is visible to an observer outside of the vehicle;
a sensor configured to sense at least one of: a condition of the vehicle or an ambient condition around the vehicle; and
a controller configured to adjust the visual content shown on the display unit based on the at least one of the condition of the vehicle or the ambient condition around the vehicle.

12. The V2X communication system of claim 11, wherein adjusting the visual content further includes adjusting a display resolution of the visual content shown on the display unit.

13. The V2X communication system of claim 11, wherein adjusting the visual content includes adjusting a size of the visual content shown on the display unit.

14. The V2X communication system of claim 11, wherein adjusting the visual content includes reducing the visual content shown on the display unit.

15. The V2X communication system of claim 11, wherein adjusting the visual content includes:
providing, to a large language model (LLM), the at least one of the condition of the vehicle or the ambient condition around the vehicle as one or more prompts; and
generating, by the LLM, a revised visual content based on the one or more prompts provided thereto.

16. The V2X communication system of claim 11, wherein the at least one of the condition of the vehicle or the ambient condition around the vehicle includes a speed of the vehicle.

17. The V2X communication system of claim 11, wherein the at least one of the condition of the vehicle or the ambient condition around the vehicle includes a distance to an object outside of the vehicle.

18. The V2X communication system of claim 11, wherein the at least one of the condition of the vehicle or the ambient condition around the vehicle includes an object type of an object outside of the vehicle.

19. The V2X communication system of claim 11, wherein the at least one of the condition of the vehicle or the ambient condition around the vehicle includes a weather condition around the vehicle.

20. The V2X communication system of claim 11, further including a wireless data radio onboard the vehicle and configured to receive data regarding the ambient condition around the vehicle.
